(19) United States
(12) Patent Application Publication
(10) Pub. No.: US 2009/0217983 A1
(43) Pub. Date: Sep. 3, 2009

(54) HYDRAULIC VALVE ASSEMBLY

(75) Inventors: Wolfgang Kauss, Francheville (FR); Vincenzo Bollero, Rivarolo Canavese (Torino) (IT)

Correspondence Address: MICHAEL J. STRIKER, 103 EAST NECK ROAD, HUNTINGTON, NY, 11743, US

(73) Assignee: ROBERT BOSCH GMBH, STUTTGART (DE)

(21) Appl. No.: 12/282,686

(22) PCT Filed: Feb. 8, 2007
(86) PCT No.: PCT/EP07/01051

§ 371 Date: Dec. 10, 2008

(30) Foreign Application Priority Data
Mar. 14, 2006 (DE) 10-2006-012-030.2

(51) Int. Cl. F16K 17/02

(52) U.S. Cl. 137/115.13

(57) ABSTRACT

The invention relates to a hydraulic valve arrangement which is used, in particular, for a mobile machine and which has a valve housing (10) having a feed channel (34), having an outlet channel (42) and having a consumer channel (39) and has a valve bore (11) which cuts into the channels. In the valve bore (11), a valve slide (12) can be moved axially from a neutral position in at least one direction into a working position, by way of which valve slide (12) the fluidic connections between the channels can be controlled. Moreover, there is a pressure-relief and feed valve (45, 47), by way of which the pressure in the consumer channel (39) can be limited by throttled discharge of pressure fluid into the outlet channel (42) and pressure fluid can be fed from the outlet channel (42) into the consumer channel (39). The invention is based on the object of designing a hydraulic valve arrangement of this type in such a way that low manufacturing costs and a small overall size are possible. According to the invention, the object which is aimed at is achieved by the pressure-relief and feed valve (45, 47) being accommodated in a hollow space of the valve slide (12).

The invention relates to a hydraulic valve assembly, which is used in particular for controlling hydraulic consumers of mobile work machines and which has the characteristics of the preamble to claim 1.

One such valve assembly is known for instance from German Patent Disclosure DE 199 48 232 A1 or DE 103 25 294 A1, European Patent Disclosure EP 1 092 095 B1, or from the Data Sheet RD 64 295/07.02 or RD 64 282/05.00 of the present Applicant and can be embodied as a single valve disk, which can be combined with other valve disks into a control block, or as a valve disk of a so-called monoblock. The valve disks in these references are embodied as so-called load-sensing valves, and in a valve bore of a valve housing they contain a valve slide, with which the opening cross section of a metering aperture and the flow direction of the pressure fluid in the existing consumer conduits can be controlled.

In the valve housings, in a further bore, a pressure balance is also accommodated in a further bore; in the case of the valve disk in Data Sheet RD 64 282/05.00, it is located upstream of the metering aperture, and its regulating piston is urged in the closing direction by the pressure upstream of the metering aperture and in the opening direction by the pressure downstream of the metering aperture and by a spring. In the case of the valve disks of the other references, the pressure balance is located downstream of the metering aperture and is urged in the closing direction by the maximum load pressure of all the simultaneously actuated hydraulic consumers and in the opening direction by the pressure downstream of the metering aperture. Such valve disks make a flow distribution that is independent of load pressure possible, if at the same time a plurality of hydraulic consumers are to be supplied with pressure fluid, and the quantity of pressure fluid pumped by a pump is less than the required quantity of pressure fluid.

Moreover, the known valve disks in the valve housing have two pressure-limiting and feed valves, each of which is associated with one of the two consumer conduits. A pressure-limiting and feed valve of this kind responds regardless of the position of the valve slide when the pressure in the corresponding consumer conduit reaches a defined value, and it limits the pressure to that value by causing pressure fluid to flow out of the consumer conduit in throttled fashion to the outflow conduit (pressure limiting function). This can happen for instance if the valve slide, in the neutral position blocks off the consumer conduit, and pressure fluid located in the consumer conduit, in a consumer line connected to it, and in the hydraulic consumer itself heats up, and if the hydraulic consumer is located at a stop.

The pressure-limiting and feed valve also responds when the load is acting in the desired direction of motion, and the pressure in the consumer conduit, by way of which pressure fluid flows to the hydraulic consumer, drops below the pressure in the outflow conduit (feed function). The pressure in the outflow conduit can be raised to above atmospheric pressure with the aid of a backup valve.

A pressure-limiting and feed valve is not always connected to a consumer conduit. For certain applications, it suffices for a pressure-limiting and feed valve to be associated with only one of the two consumer conduits of a valve disk. Sometimes, a valve disk has no pressure-limiting and feed valve whatever. For the various different uses, different valve housings must therefore be manufactured and upon assembly combined with the correct valve slides. This involves considerable handling costs. Since having to cast different blanks is undesirable, the cast valve housings are always made with installation spaces for two pressure-limiting and feed valves.

The object of the invention is to develop a hydraulic valve assembly, having the characteristics of the preamble to claim 1, further in such a way that lower production costs and smaller size are possible.

The stated goal is attained, in a hydraulic valve assembly having the characteristics of the preamble to claim 1, according to the invention in that according to the body of claim 1, the pressure-limiting and feed valve is accommodated in a hollow chamber of the valve disk. In such an embodiment, the valve housing can be a standard element, whose rough form and further design no longer need to depend on whether the valve disk is intended to hold one, or two, or no pressure-limiting and feed valves. Installation space for the pressure-limiting and feed valves no longer has to be reserved in the valve housing, and thus the valve housing can be smaller than in known valve disks. The various variants of valve disks are not formed until near the end of the manufacturing process, using a suitable valve slide that is already adapted in other respects to the particular application. As needed, the valve slide can receive one or two pressure-limiting and feed valves.

Advantageous features of a hydraulic valve assembly according to the invention can be found in the dependent claims.

An especially expedient embodiment is found in claim 3, according to which the valve slide is movable from the neutral position into work positions in both directions, and according to which the hollow chamber in the valve slide can be made to communicate with the outflow conduit via a radial bore, which is located so close to one end of the valve slide that, upon a displacement of the valve slide from the neutral position, it is closed toward the outflow conduit in the sense of a communication of the second consumer conduit with an inflow conduit. This embodiment is based on the concept that, in a work position of the valve slide in which the consumer conduit communicates with the outflow conduit, the hollow chamber in the valve slide need not be open toward the outflow conduit. Accordingly, the radial bore can be located far outward, to the end of the valve slide. A long stroke of the valve disk can be preserved. The control chamber, which forms the outflow conduit at the valve bore, need not be enlarged axially.

Various versions of pressure-limiting and feed valves exist that can be built into the valve slide; the various versions can differ in their structural length or in the feed flow cross section. If according to claim 4, toward the consumer conduit, two radial bores discharge into the hollow chamber and are spaced apart from one another in the axial direction of the valve slide, and of them, in one work position of the valve slide, one radial bore is open toward the consumer conduit and the other radial bore is open toward the inflow conduit or the outflow conduit, then it is possible to use a certain version of a pressure-limiting and feed valve for which the hollow chamber, with a large diameter, must reach into a region of the valve slide in which the valve slide in the known valve assemblies has an annular groove in order to establish the various fluidic communications. In the embodiment, the hollow chamber is also located in the fluidic communication of the consumer conduit with the inflow conduit or the outflow conduit. An annular groove is unnecessary.

If another version of a pressure-limiting and feed valve is used that does not necessitate having the hollow chamber with a large diameter extend far into the valve slide, and if the valve slide according to claim 5, in the region of the consumer conduit, has an annular groove by way of which the consumer conduit can be made to communicate with an inflow conduit or with the outflow conduit, then, as recited in claim 6, a radial bore advantageously extends into the hollow chamber from the annular groove. Via this radial bore, pressure fluid then flows only whenever the pressure-limiting and feed valve responds.

Claim 7 is directed to a hydraulic valve assembly having a pressure-limiting and feed valve that can be constructed with an especially small diameter, so that the wall of the valve slide surrounding the hollow chamber can be thick enough that it readily meets all the demands made of it with regard to dimensional stability and security against breakage. The pressure-limiting and feed valve of claim 7 can be refined advantageously in accordance with claims 8 through 11.

A plurality of exemplary embodiments, embodied as LIFD valves, of a hydraulic valve assembly according to the invention are shown in the drawings.

The invention will now be described in further detail in conjunction with these drawings.

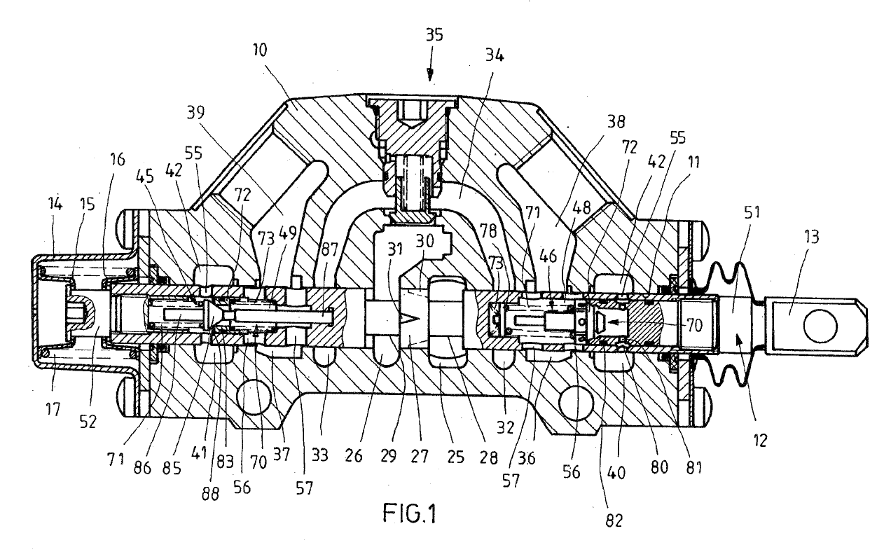

FIG. 1 shows a longitudinal section through a valve disk having two consumer conduits and one valve slide, in which the valve slide accommodates two pressure-limiting and feed valves of different design;

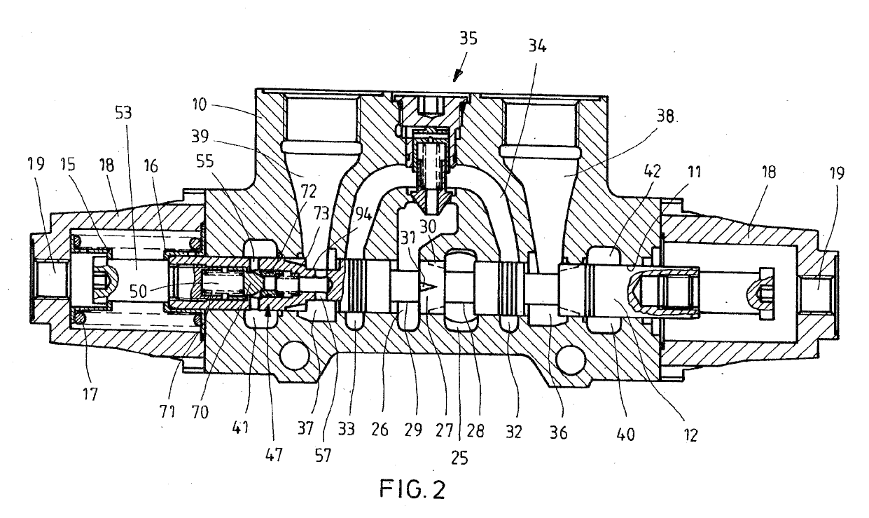

FIG. 2 shows a longitudinal section through a valve disk having two consumer conduits and one valve slide, in which only one pressure-limiting and feed valve, in a third version, is accommodated in the valve slide;

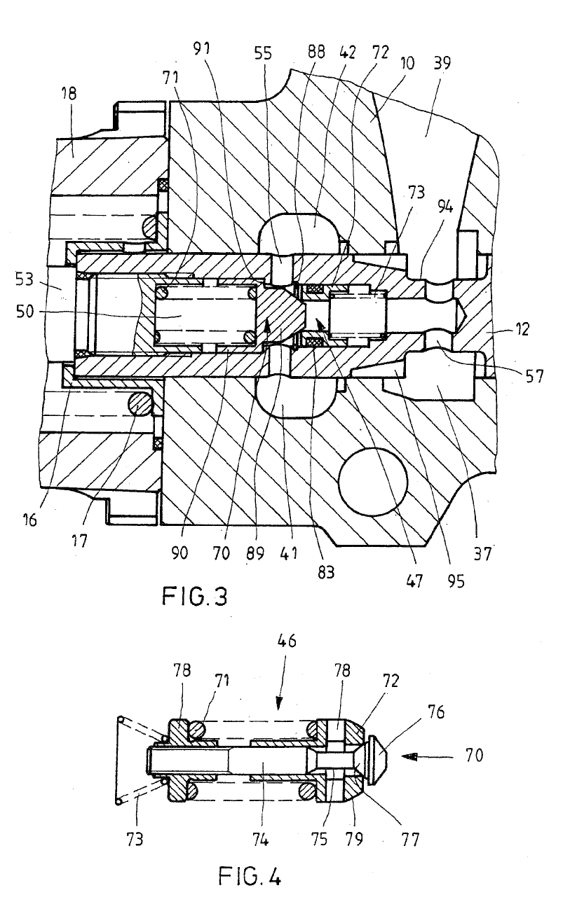

FIG. 3 is an enlarged view of the valve disk of FIG. 2 in the region of the pressure-limiting and feed valve; and

FIG. 4 is a longitudinal section through one of the two pressure-limiting and feed valves in FIG. 1.

The valve slides in FIGS. 1 and 2 have a disklike valve housing 10, through which a valve bore 11, located in a central disk plane, passes. A valve slide 12 is axially movable in this bore. In the exemplary embodiment of FIG. 1, the valve slide is mechanically actuatable and to that end, on an end protruding from the valve housing 10, it has a pivot with cheeks 13, on which a hand lever can be secured. On the other end of the valve slide 12, which likewise protrudes from the valve housing 10, but which is covered by a cap 14 screwed onto the valve housing, a helical compression spring 17 is tethered with two spring cups 15 and 16 inside the cap, and this spring centers the valve slide in a neutral position, and upon each motion of the valve slide out of the neutral position, regardless of the direction of the motion, is compressed more markedly, beginning at a basic initial tension.

In the exemplary embodiment of FIG. 2, the valve slide is hydraulically actuatable. For that purpose, both ends of the valve slide 12 that protrude from the valve housing 10 are covered with solid caps 18, which are screwed onto the valve housing 10 and have a connection opening 19 for a control line. With the aid of a hydraulic pilot control unit, a control pressure can be fed into one or the other cap via the control lines, and this pressure generates a force on the cross-sectional area of the valve slide 12 that displaces the valve slide far enough toward the helical compression spring 17, which as in the first exemplary embodiment is tethered between two spring cups 15 and 16, that an equilibrium prevails between the compression force and the spring force.

The valve bore 11, in both exemplary embodiments, is surrounded by eight control chambers axially spaced apart from one another, which serve to control the inflow of hydraulic fluid from a hydraulic pump to a hydraulic consumer, such as a hydraulic cylinder, and from the hydraulic consumer to a tank. Between each three control chambers on both sides are two control chambers 25 and 26, which in the neutral position of the valve slide 12 as shown in FIGS. 1 and 2 are fluidically separated from one another by a slide collar 27, which is adjoined on both sides by a slide neck with a respective annular groove 28 and 29 and which has two rows of fine-control grooves 30 and 31, are offset from one another in the circumferential direction, of which the fine-control grooves 30 are open toward the annular groove 28, and the fine-control grooves 31 are open toward the annular groove 29. The control chamber 25 is intended for connection to a pump line and can therefore also be called a pump chamber. Let it be assumed that the control chamber 26 is an intermediate chamber. Depending on the direction in which the valve slide 12 moves from the neutral position, a flow cross section from the pump chamber 25 to the intermediate chamber 26, which forms the metering aperture of the valve assembly, is opened by either the fine-control grooves 30 or the fine-control grooves 31.

One inflow chamber 32 is located on one side of the two control chambers 25 and 26, and another inflow chamber 33 is located on the other side. These two inflow chambers are part of a bridgelike inflow conduit 34, which the hydraulic fluid reaches from the intermediate chamber 26 via a pressure balance 35. All that needs to be said here about this pressure balance is that its one-piece (FIG. 1) or two-piece (FIG. 2) regulating piston is urged in the closing direction by the highest load pressure of all the hydraulic consumers that are simultaneously actuated, and optionally by a weak spring, and in the opening direction by the pressure in the intermediate chamber 26. The pressure balance is accordingly located downstream of the metering aperture and in the intermediate chamber backs up a pressure that results from the applicable highest load pressure. The valve assemblies shown in FIGS. 1 and 2 are accordingly LIFD valves.

The inflow chamber 32 is followed by a consumer chamber 36, and the inflow chamber 33 is followed by a consumer chamber 37. Each consumer chamber is part of a respective consumer conduit 38 and 39, which ends in a consumer connection of the valve housing 10. Each consumer chamber 36 and 37 is followed by a respective outflow chamber 40 and 41. The two outflow chambers are joined together in a completed valve block and are part of an outflow conduit 42, which leads to a tank connection, optionally via a backup valve.

In the neutral position of the valve slide 12, all the control chambers 25, 26, 32, 33, 36, 37, 40 and 41 are blocked off from one another. If the valve slide 12 is moved out of the neutral position, then the metering aperture is opened by the fine-control grooves 30 or 31. Moreover, one consumer chamber is opened toward an inflow chamber, and the other consumer chamber is opened toward an outflow chamber.

In addition to the components described thus far, the valve disk of FIG. 1 also has two pressure-limiting and feed valves 45 and 46, and the valve disk of FIG. 2 also has one pressure-limiting and feed valve 47. According to the invention, each of the pressure-limiting and feed valves are accommodated in a respective hollow chamber 48, 49 (FIG. 1) and 50 (FIG. 2) of the valve slide 12. In FIG. 1, the valve slide is equipped with two different pressure-limiting and feed valves.

The hollow chambers 48, 49 and 50 are each introduced into the main part from a face end of a main part of the valve slide 12, and are closed by a respective end piece 51, 52 or 53 that is screwed into the main part. In the closed position, the pressure-limiting and feed valves separate a first region of a hollow chamber, on the side toward the outflow chamber, from a second region of a hollow chamber, toward a consumer chamber. The first region is open to the outside of the valve slide 12, via a radial bore 55 in the valve slide. The radial bore 55 in turn, in the neutral position and upon an adjustment of the valve slide in a direction in which the corresponding consumer chamber 36 or 37 communicates with the associated inflow chamber, is open toward the applicable outflow chamber 40 or 41. Upon an adjustment of the valve slide 12 in the other direction, the radial bore 55 is closed after a short distance. This has no effects in terms of the function whatever, since the corresponding consumer chamber already communicates with the outflow chamber via the valve slide anyway.

The second region of the two hollow chambers 48 and 49 of FIG. 1 is open toward the outside of the valve slide, via two axially spaced-apart rows of radial bores 56 and 57, respectively. In the neutral position, shown in FIG. 1, of the valve slide 12, the bores 56 and 57 are open on the outside toward the respective consumer chamber 36 and 37. If the valve slide 12 is moved out of the neutral position, to the right in the view in FIG. 1, then the radial bores 57 of the hollow chamber 48 remain open toward the consumer chamber 36, while the radial bores 56 are closed toward the consumer chamber 36 and are opened toward the outflow chamber 40. Moreover, the radial bores 56 of the hollow chamber 49 remain open toward the consumer chamber 37, and the radial bores 57 of the hollow chamber 49 are closed toward the consumer chamber 37 and opened toward the inflow chamber 33. Hydraulic fluid arriving from the metering aperture and the pressure balance can accordingly now flow from the inflow chamber 33, the radial bores 57, the second region, and the radial bores 56 of the hollow chamber 49 of the consumer chamber 37, and from there to a hydraulic consumer. Hydraulic fluid flowing back from this hydraulic consumer reaches the outflow chamber 40, via the consumer chamber 36, the radial bores 57, the second region, and the radial bores 56 of the hollow chamber 48. Thus in the exemplary embodiment of FIG. 1, the two regions of the hollow chambers 48 and 49 are located in the fluid path of the operating fluid and each replace one annular groove on the valve slide. An advantageous aspect of this is that the hollow chambers can have a large diameter far into the valve slide. This is favorable for accommodating pressure-limiting and feed valves that are embodied in a specific way.

Each of the pressure-limiting and feed valves 45, 46 and 47 has a valve body 70, which is urged in the opening direction by the pressure in the corresponding consumer chamber and in the closing direction by the pressure in the adjacent outflow chamber and by a strong helical compression spring 71, whose pressure equivalent may for example be 300 bar, and for limiting the pressure in a consumer chamber, each pressure-limiting and feed valve opens a flow cross section from that consumer chamber to the adjacent outflow chamber. Moreover, each pressure-limiting and feed valve has a valve body 72, which is urged in the closing direction by the pressure in the corresponding consumer chamber and in the opening direction by the pressure in the adjacent outflow chamber and by a weak helical compression spring 73, whose pressure equivalent may for example be 0.5 bar. If the pressure in the consumer chamber drops below the pressure in the outflow chamber by more than the pressure equivalent of the helical compression spring 73, the valve body 72 opens a flow cross section, so that hydraulic fluid is fed from the outflow chamber into the consumer chamber.

In the case of the pressure-limiting and feed valve 46 in FIGS. 1 and 4, the valve body 70 has a guide rod 74, and downstream of a plunge cut 75, extending all the way around, the guide rod has a closing cone 76, which has a conical seat face 77 toward the plunge cut. The valve body 72 is thrust onto the guide rod 74; around the plunge cut 75, it has an annular groove and a plurality of radial bores 78, beginning at the annular groove, and protrudes radially past the closing cone 76, and outside the closing cone, it has a conical seat face 77 oriented counter to the seat face 77 of the closing cone. After the valve body 72, the helical compression spring 71 is thrust onto the guide rod 74. Behind it, a spring cup 78 is screwed onto the guide rod 74, so that the helical compression spring 71 is fastened between the valve body 72 and the spring cup 78 and presses the closing cone 76, with its conical seat face 77 against an inner seat edge of the valve body 72. The seat diameter is equal to the diameter of the guide rod 74. The parts of the pressure-limiting and feed valve 46 mentioned such thus far are accordingly combined in captive fashion into one unit. The valve also includes the helical compression spring 73, which after assembly is located between the spring cup 78 and the bottom of the hollow chamber 46. The seat edge for the seat face 79 of the valve body 72 is embodied on the end piece 51 of the valve slide 12. For that purpose, the end piece reaches with a hollow portion to beyond the radial bores 55 of the valve slide 12, into the hollow chamber 46. The valve body 72, in the position of repose, is seated on an inner edge of the face end of the end piece. The first region of the hollow chamber 46 is thus embodied entirely inside the end piece 51. For fluidic communication outward to the radial bores 55 in the main part of the valve slide 12, the end piece has an annular groove 80 on the outside, at the level of the radial bores 55, and also radial bores 81 extending inward from the annular groove. Between the annular groove 80 and the face end of the end piece 51, between the end piece and the inner wall of the valve slide 12 is a sealing ring 82 that rests in an annular groove of the end piece.

In operation, the pressure prevailing in the consumer chamber 36 acts on the valve body 70 in the direction of opening, on an area that is defined by the diameter of the guide rod 74. The helical compression spring 71, which is braced on the end piece 51 via the valve body 72, keeps the closing cone 76 of the valve body 70, with its face 77 in contact with the valve body 72, as long as the pressure in the consumer chamber, taking into account the pressure prevailing in the outflow chamber 40, does not exceed the pressure equivalent of the spring. As soon as that pressure is exceeded, the valve body 70, or in other words the guide rod 74 together with the closing cone 76, is displaced to the right—in the views in FIGS. 1 and 4—so that a flow cross section between the closing cone 76 and the valve body 72 opens, and hydraulic fluid flows in throttled fashion out of the consumer chamber 36 into the outflow chamber 40. The pressure in the consumer chamber 36 is thus limited to the pressure at which the valve body 70 opens.

In the above-described configuration, the valve body 72 remains in repose. Conversely, if the pressure in the consumer chamber 36 drops below the pressure in the outflow chamber 40 by more than the pressure equivalent of the helical compression spring 70, then the valve body 70, the valve body 72, and the helical compression spring 71 are displaced as a unit counter to the helical compression spring 73, until the guide rod 74 meets the bottom of the hollow chamber 46. Between the valve body 72 and the face end of the end piece 51, a flow cross section opens up, by way of which hydraulic fluid can flow virtually unthrottled from the outflow chamber 40 to the consumer chamber 36. Thus in the consumer chamber 36 and in the lines and consumer chambers communicating with it, the creation of an underpressure is reliably avoided.

The pressure-limiting and feed valve 45 of FIG. 1 also has one valve body 70, which serves the purpose of pressure limitation, and one valve body 72, which serves the purpose of feeding. The valve body 72 is embodied as a ring with a central opening and is located axially between the radial bores 55 and 56 of the valve slide 12. On an inner shoulder, it is urged in a direction out of the hollow chamber by the weak helical compression spring 73, which is also braced on a shoulder of the hollow chamber 49. A sealing ring 83 is located in an outer annular groove of the valve body 72. From a position of repose, which is shown in FIG. 1, the valve body 72 can be moved counter to the force of the helical compression spring 73 until it is against a further shoulder of the hollow chamber 49, and in the position that the valve body 72 then assumes, the radial bores 56 remain open to the hollow chamber 49.

The valve body 70 of the pressure-limiting and feed valve 45 includes a closing cone 85, which is located in the region of the hollow chamber 49 toward the outflow chamber and which can be seated, with a conical face, on an edge of the central opening in the valve body 72; a stop finger 82, which points toward the end piece 52; the strong helical spring 71, which is fastened, surrounding the stop finger 86, between the closing cone 85 and the end piece 52; and a bracing rod 87, which passes through the valve body 72, extends into the interior of the helical compression spring 73, and on the far side of the radial bores 57 dips into an end portion of the hollow chamber 49 and braces the closing cone 85, in its position of repose, on the valve slide 12 counter to the action of the helical compression spring 71. It is advantageous here that given a suitable choice of the sealing of the hollow chamber by the end piece 52, the initial tension of the helical compression spring 71 can be varied, even after the installation of the pressure-limiting and feed valve 45, by rotating the end piece 52 that is screwed into the main part of the valve slide 12.

In the position of repose of the two valve bodies 70 and 72 and without pressures in the chambers 37 and 41, the valve body 72 rests, under the influence of the helical compression spring 73, on the closing cone 85 of the valve body 70 that is braced on the valve slide 12 via the bracing rod 87. The valve body 72 then has a slight spacing from a stop ring 88, which is inserted into the valve slide and which limits the travel of the valve body 72 toward the radial bores 55 upstream of them.

In operation, when the valve slide is in the neutral position or in a work position, in which the consumer chamber 37 communicates fluidically with the inflow chamber 33, the pressure prevailing in the consumer chamber 37 acts on the valve bodies 70 and 72 counter to the helical compression spring 71 and counter to a backup pressure that may prevail in the outflow chamber. The first effective area for the consumer chamber pressure is initially determined by the diameter of the valve body 72. If the consumer chamber pressure rises to such a value that the compression force generated at the first effective area reaches the force of the helical compression spring 71, then the valve bodies are moved so far that the valve body 72 reaches the stop ring 88. From that point on, the consumer chamber pressure can now generate a compression force on the valve body 70, directed counter to the force of the helical compression spring 71, only at a surface area determined by the diameter of the central opening in the valve body 72. If the consumer chamber pressure now reaches the value predetermined by the initial tension of the helical compression spring 71, the valve body 70 lifts from the valve body 72, so that a flow cross section opens between the closing cone 85 of the valve body 70 and the valve body 72, and hydraulic fluid flows, throttled, out of the consumer chamber 37 into the outflow chamber 41. The pressure in the consumer chamber 37 is thus limited to the pressure at which the valve body 70 lifts from the valve body 72.

Conversely, if the pressure in the consumer chamber 37 drops below the pressure in the outflow chamber 41 by more than the pressure equivalent of the helical compression spring 73, then the valve body 72 is lifted, counter to the helical compression spring 73, from the closing cone 85, braced via the rod 87, of the valve body 70 and is pressed against the aforementioned shoulder of the valve slide. Between the valve body 72 and the closing cone 85, a flow cross section opens by way of which hydraulic fluid can flow virtually unthrottled from the outflow chamber 41 to the consumer chamber 37. The helical compression spring 73 is still far away from being compressed into a block, and thus the hydraulic fluid can flow freely to the radial bores 56.

The pressure-limiting and feed valve 47 in FIGS. 2 and 3, in its fundamental construction, is equivalent to the valve 45 in FIG. 1. In particular, the valve body 72 with the seal 83 is the same as in FIG. 1. A helical compression spring 73 and a stop ring 88 for the valve body 72 are located in the same way as the valve 45 in FIG. 1.

What is designed differently is the valve body 70. This valve body now has a collar 90, pointing in the direction of the end piece 53 and offset radially outward from a closing cone 89; with this collar, it can rest in the direction of the effective force of the helical compression spring 71 on a shoulder 91, located upstream of the radial bores 55, of the valve slide 12, on the one hand, and on the other, it can rest, counter to the effective force of the helical compression spring 71, on the end piece 53. The possible travel of the valve body 70 results, in the illustration in FIGS. 2 and 3, from the inside spacing of the collar 90 from the end piece 53.

The pressure-limiting and feed valve 47 in FIGS. 2 and 3 is distinguished over the valves 45 and 46 in that its components are not located as deep in the valve slide 12 and therefore the dimensions of the hollow chamber 50 for accommodating the valve 47 can be smaller than those of the hollow chambers 48 and 49 in FIG. 1. The valve slide 12 of the exemplary embodiment of FIGS. 2 and 3 is provided, not only in the region of the consumer chamber 36 but also in the region of the consumer chamber 37, with an annular groove 94, which serves the purpose of fluidic communication of the consumer chamber 37 with the inflow chamber 33 and with the outflow chamber 41. The communication with the inflow chamber 33 is established via an encompassing edge, and the communication with the outflow chamber 41 is established via outflow grooves 95.

The hollow chamber 50, as a bore of relatively small diameter, extends into the region of the annular groove 94 and is open there toward the annular groove via the radial bores 57 that discharge into the annular groove. In a distinction from the exemplary embodiment of FIG. 1, the radial bores 57 are now not located in the normal fluid path of the hydraulic fluid flowing from the inflow chamber 33 to the consumer chamber 37, or the hydraulic fluid flowing away from the consumer chamber 37 to the outflow chamber 41. Radial bores that correspond to the radial bores 56 of the exemplary embodiment of FIG. 1 are not present in the exemplary embodiment of FIGS. 2 and 3.

The pressure-limiting and feed valve 47 functions precisely like the pressure-limiting and feed valve 45 in FIG. 1. In the pressure limiting function, hydraulic fluid flows out of the consumer chamber 37 to the outflow chamber 41, via the radial bores 57, the second region of the hollow chamber 50, a throttle cross section between the valve bodies 70 and 72, the first region of the hollow chamber, and the radial bores 55. In the feed function, the hydraulic fluid takes the reverse course, but the flow cross section between the two valve bodies 70 and 72 is then wide open, and the pressure drop between the outflow chamber 41 and the consumer chamber 37 is only slight.

1. A hydraulic valve assembly, in particular for a mobile work machine, having a valve housing (10) that has an inflow conduit (34), an outflow conduit (42), and a consumer conduit (39) as well as a valve bore (11) that intersects the conduits; having a valve slide (12) that is axially movable in at least one direction from a neutral position into a work position, with which valve slide the fluidic communications between the conduits are controllable; and having a pressure-limiting and feed valve (45; 47), with which, by throttled drainage of pressure fluid into the outflow conduit (42), the pressure in the consumer conduit (39) is limitable and pressure fluid is capable of being fed from the outflow conduit (42) into the consumer conduit (39),
characterized in that
the pressure-limiting and feed valve (45; 47) is accommodated in a hollow chamber (49; 50) of the valve slide (12).

2. The hydraulic valve assembly as defined by claim 1, characterized in that the valve housing (10) has a second consumer conduit (38); that the valve slide (12) is movable in both directions from the neutral position into work positions and has a second hollow chamber (48); and that in the second hollow chamber (48), a second pressure-limiting and feed valve (46) is accommodated, with which, by throttled drainage of pressure fluid into an outflow conduit (42), the pressure in the second consumer conduit (38) is limitable and pressure fluid is capable of being fed from the outflow conduit (42) into the second consumer conduit (38).

3. The hydraulic valve assembly as defined by claim 1, characterized in that the valve slide (12) is movable in both directions from the neutral position into work positions; and that the hollow chamber (48, 49, 50) in the valve slide (12) is capable of being made to communicate with the outflow conduit (42) via a radial bore (55), which upon a displacement of the valve slide (12) from the neutral position is closed toward the outflow conduit in the direction of a communication of the consumer conduit (38, 39) with the outflow conduit (42).

4. The hydraulic valve assembly as defined by claim 1, characterized in that two radial bores (56, 57) discharge into the hollow chamber (48, 49) on the consumer conduit side, which bores are spaced apart from one another in the axial direction of the valve slide (12); and that in a work position of the valve slide (12), one radial bore (56, 57) is open toward the consumer conduit (38, 39), and the other radial bore (57, 56) is open toward the inflow conduit (34) or the outflow conduit (42).

5. The hydraulic valve assembly as defined by claim 1, characterized in that the valve slide (12), in the region of the consumer conduit (39), has an annular groove (94) by way of which the consumer conduit (39) can be made to communicate with the inflow conduit (34) or the outflow conduit (42).

6. The hydraulic valve assembly as defined by claim 5, characterized in that from the annular groove (94), a radial bore (57) leads into the hollow chamber (50) having the pressure-limiting and feed valve (47).

7. The hydraulic valve assembly as defined by claim 1, characterized in that a pressure-limiting and feed valve (45, 47) has a first movable valve body (70) and a second movable valve body (72), of which one is embodied as a closing cone (85, 89), and the other is embodied as a valve seat capable of being seated on the closing cone, of which one is urged by a strong spring (71) and the other is urged by a weak spring (73) in the direction of the respective other valve body and which are movable in opposite directions for opening the pressure-limiting and feed valve (45, 47) counter to the force of the respective spring; and that the motion of the valve bodies (70, 72) toward one another is limited by slide-proof stops (88, 91), whose spacing from one another is dimensioned such that the valve body (72) urged by the weak spring (73) has a slight spacing from its slide-proof stop (88), when the valve body (70) urged by the strong spring (71) rests on its slide-proof stop (91) and the other valve body (72) is seated on it.

8. The hydraulic valve assembly as defined by claim 7, characterized in that the valve body (70) having the closing cone (89) has a stop collar (90) that is spaced apart from the valve seat and offset radially outward.

9. The hydraulic valve assembly as defined by claim 7, characterized in that the slide-proof stop (91) for limiting the motion of the one valve body (70) deeper into the valve slide (12) and toward the other valve body (72) is formed by a shoulder in a hollow chamber (50).

10. The hydraulic valve assembly as defined by claim 7, characterized in that the closing cone (85) is capable of being braced on a slide-proof stop, via a rod (87) that passes through the valve seat (72).

11. The hydraulic valve assembly as defined by claim 7, characterized in that a seal (83) is located between the outside of the valve seat (72) and the wall of the hollow chamber (49, 50).
